(19) United States
(12) Patent Application Publication
(10) Pub. No.: US 2011/0250338 A1
(43) Pub. Date: Oct. 13, 2011

(54) Adsorption Purification Of Caramel

(75) Inventors: Setlur Ranganna Ramaswamy, Louisville, KY (US); Charles Walberg, Bronx, NY (US)

(73) Assignee: PepsiCo., Inc., Purchase, NY (US)

(21) Appl. No.: 13/069,446

(22) Filed: Mar. 23, 2011

Related U.S. Application Data
(60) Provisional application No. 61/321,919, filed on Apr. 8, 2010.

(51) Int. Cl. A23L 1/015; A23L 1/27

(52) U.S. Cl. 426/540

(57) ABSTRACT

A process of purifying a caramel color solution comprising introducing the caramel color solution into an adsorbent wherein the adsorbent adsorbs 4-MeI to form a purified caramel color solution, and adding an acid to the purified caramel color solution to lower the pH to less than 5.

This application claims benefit from U.S. Provisional application No. 61/321,919, filed Apr. 8, 2010, the whole contents of which are incorporated herein by reference in its entirety.

### FIELD OF THE INVENTION

The invention relates to a process for removing 4-methyl-imidazole (4 MeI) a reaction byproduct from caramel color, in particular the invention relates to removing 4 MeI by adsorption purification.

### BACKGROUND OF THE INVENTION

Caramel colors are food ingredients used to impart brown color of varying shade and intensity to a wide range of foods and beverages. By far, the largest use of caramel colors is in cola beverages. Significant amounts of caramel colors are also used in beer, bakery products, soy sauce, and distilled spirits.

Caramel colors are of different physical characteristics and composition. The soft drink caramel colors are made by reacting any acceptable food grade carbohydrate with ammonium sulfites. The brewery caramel colors are made by reacting carbohydrates with ammonia only. The caramel color used in high alcohol content distilled spirits is obtained by heating sugar with sodium hydroxide.

Caramel used in beverages to impart its brown color contains parts per million (ppm) quantities of 4-methyl imidazole (hereafter 4 MeI) which need to be removed or at least drastically reduced. A particular problem with caramel color prepared in an ammonia process is the production of MeI. It is believed that 4-MeI is a reaction product of the carbohydrates in combination with the ammonia catalyst used in the process. The Food and Drug Administration has limited the content of 4-MeI in caramel color.

### BRIEF SUMMARY OF THE INVENTION

Aspects of the invention are directed to the removal of 4 MeI found in caramel color solutions by mixing the caramel color solution with adsorbents.

In accordance with one aspect of the present invention, a caramel color solution is introduced into an adsorbent wherein the adsorbent adsorbs 4-MeI and a purified caramel solution is formed. An acid may then be added to the purified caramel color solution to lower the pH to levels suitable for a beverage, generally less than 5.

In a particular aspect of the invention, a caramel color solution is introduced into an adsorption column containing a fixed bed adsorbent, wherein the adsorbent removes 4-MeI; the purified caramel color solution is removed from the adsorption column; and an acid is added to the purified caramel color solution to lower the pH to less than 5.

In a further aspects of the invention, prior to introducing the caramel color solution into an adsorbent, the caramel color solution is mixed with an alkali in an amount effective to raise the pH of the caramel solution to foster adsorption of the 4-MeI from the caramel color solution. For example, the pH may be raised to at least 6.5.

### BRIEF DESCRIPTION OF THE DRAWINGS

FIG. 1 is a flow chart depicting a process in accordance with one aspect of the invention.

FIG. 2 depicts 4-MeI ppm in solution vs 4-MeI ppm in adsorbant.

FIG. 3 depicts 4-MeI ppm in 11KDS solution vs 4-MeI ppm in adsorbant.

### DETAILED DESCRIPTION OF THE INVENTION

Caramel color is produced by caramelizing a carbohydrate solution to form high molecular weight color bodies. U.S. Pat. No. 4,614,662, for example, discloses a continuous process utilizing ammonia sulfites to produce caramel color. However, despite efforts to reduce impurities, the ammonia caramel color solution still contains impurities, such as 4-MeI.

It was discovered that 4-MeI could be removed by raising the pH of the caramel color solution and then exposing the solution to adsorbents which adsorb the 4-MeI onto their surface.

In accordance with the present invention, a caramel color solution is treated with an alkali to raise the pH level of the solution. The alkali treated solution is mixed with adsorbents, for example in mixing vessels provided with mixers. Alternatively, the alkali treated caramel color solution can be passed through a fixed bed of adsorbents. Thus, the process may be performed in a batch, semi-continuous, or continuous manner. The spent adsorbents may be regenerated for reuse with known techniques such as steaming, roasting, or mild acid washing.

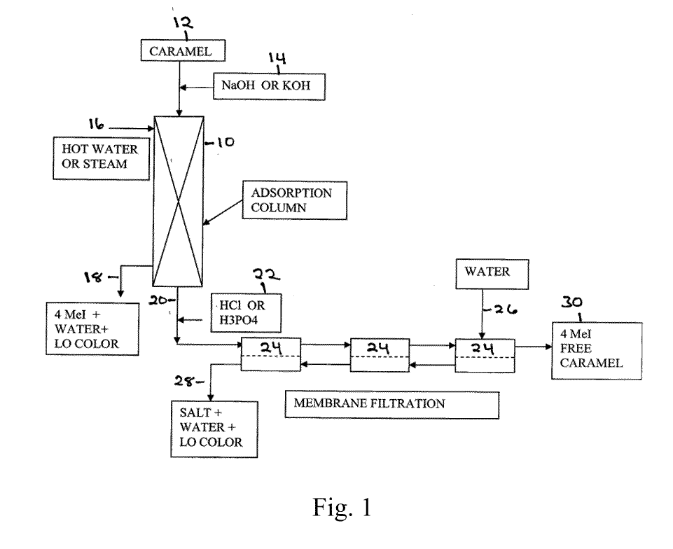

For example, as shown in FIG. 1, a caramel color solution is continuously introduced through feed line 12 into the top of an adsorption column 10. An alkali is likewise introduced into the top of the adsorption column 10, generally by introducing the alkali through feed line 14 into the feed line 12 for the caramel. Thus the caramel color solution and alkali are mixed prior to introduction into the adsorption column.

The adsorbents utilized in the adsorption column may be any suitable adsorbents that have an affinity to adsorb organic molecules with neutral or low polarities. Suitable adsorbents include activated carbon, zeolites, diatomaceous earth, and synthetic polymeric resins such as XAD resins obtained from Rohm Hass company, a division of Dow Corporation.

Prior to combining with the alkali, the caramel typically has a pH of less than 5, for instance 2 to 4, such as about 2.5.

The alkali may be any suitable alkali to raise the pH of the caramel. Suitable alkalis include, but are not limited to NaOH and KOH. The amount of alkali depends on the desired pH. Generally, it is desired to raise the pH of the caramel to at least 5.0, typically at least 6.5, for example, 6.5 to 9. After the caramel color solution is subjected to adsorption, the caramel product is removed from the bottom of the adsorption column through product line 20.

The spent adsorbents are regenerated for reuse by using known techniques such as steaming, roasting, or mild acid washing. For example, hot water or steam is introduced through feed line 16 into the adsorption column to flush the adsorbent with water to remove the impurities such as low molecular weight color compounds and salts. The waste water is removed through waste line 18. The adsorption column is ready to be reused.

After removal from the adsorption column, the alkaline purified caramel can be acidified with one or more acids though feed line 22 to lower the pH to the original pH of the caramel, generally less than 5, typically between 2 and 5. Suitable acids include, for example, HCl, H₃PO₄, citric acid, or other food-grade acids.

The continuous process of the present invention has advantages over other methods which hold the caramel color in the purification equipment for times that may be detrimental for its functionality in the beverage. In the adsorption process the purification occurs as the material continuously flows through the equipment which provides a very short process hold up time.

As noted above, instead of an adsorption column, the caramel color solution and alkali simply may be mixed with the adsorbent using mixing vessels. After a sufficient time to achieve adsorption of the impurities, the caramel color solution is separated from the adsorbent and removed from the vessel and mixed with an acid to lower the pH to give a purified useable product.

The now acid treated caramel color solution contains salts and low molecular weight color bodies. The caramel color solution is then subjected to filtration, particularly nano-membrane filtration (MWCO<1000 Daltons), to remove the salts. FIG. 1 depicts three filtration stages 24 but any suitably effective number of filtration stages may be used. The filtration renders the caramel material in a form close to the starting material.

Water is introduced in feed line 26 and is used to remove the salts and low molecular weight color bodies though lines 28. The purified caramel color product is removed via line 30.

The purified caramel is suitable for use in beverages such as colas and beer.

### Example

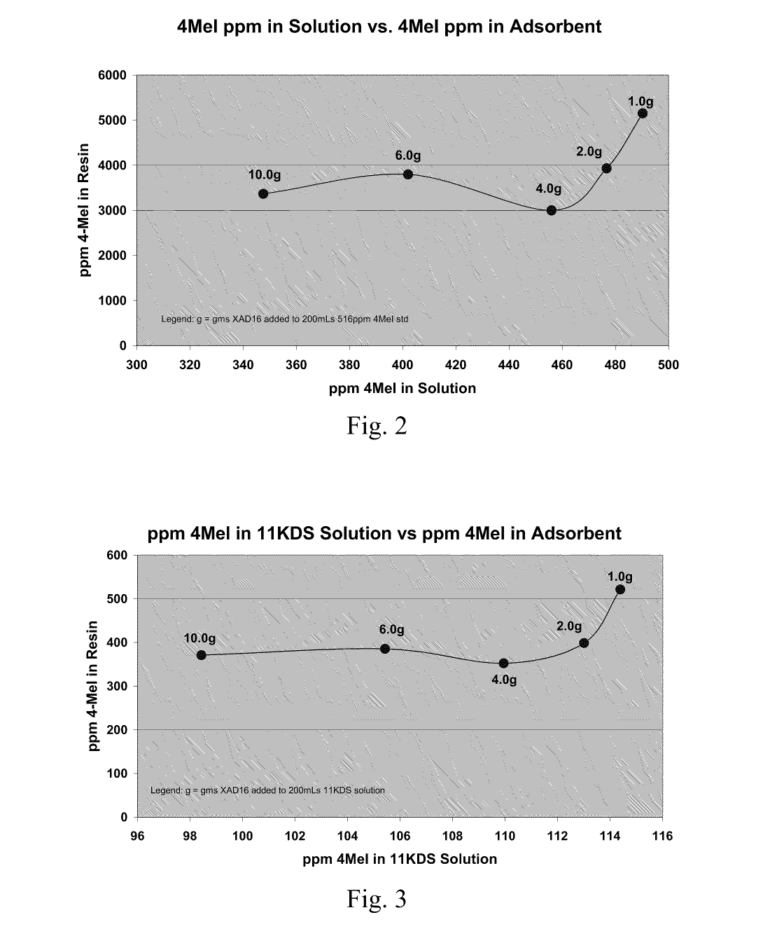

Adsorption studies of 4-MeI on to a class of synthetic adsorbents were conducted to confirm the viability of adsorption for removing the trace amounts of the 4-MeI present in caramel colors. The results are shown in Tables 1 and 2 and FIGS. 2 and 3, respectively.

TABLE 1
Changes in 4-MeI concentration after 200 mL 516 ppm
std treated by resin

| | 4-MeI (ppm) in | 4-MeI (ppm) in |
|---|---|---|
| Adsorbant (gms) | Solution | dry Resin |
| 1 | 490 | 5154 |
| 2 | 477 | 3934 |
| 4 | 456 | 3001 |
| 6 | 402 | 3799 |
| 10 | 348 | 3368 |

TABLE 2
Changes in 4-MeI concentration after 200 cc of 11KDS
treated by resin

| | 4-MeI (ppm) in | 4-MeI (ppm) in |
|---|---|---|
| Adsorbant (gms) | 11KDS | dry Resin |
| 1 | 114 | 522 |
| 2 | 113 | 399 |
| 4 | 110 | 352 |
| 6 | 105 | 386 |
| 10 | 98 | 371 |

The adsorption equilibrium data of 4 MeI between the liquid phase and the solid resin phase was obtained following the usual procedure. Fixed quantities of the 4 MeI solution (200 cc) of a known concentration (516 ppm) are added to several flasks and increasing amounts (1 to 10 gms) of fresh resin is added into these solutions. The solutions are kept gently mixed for about an hour to let the solution and the solids come to equilibrium with respect to 4 MeI. Samples of the solution phase are analyzed for 4 MeI and from it by material balance the concentration of 4 MeI on the resin is calculated. These two concentrations are plotted to get a point on the equilibrium plot. Similarly from other samples the data are plotted and connected to get the adsorption equilibrium curve.

In case of caramel color it is first analyzed for its 4 MeI content. The rest of the experiment follows the same procedure as for the pure 4 MeI and the equilibrium adsorption for 4 MeI in caramel is obtained.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A process of purifying a caramel color solution comprising:
combining the caramel color solution with an adsorbent wherein the adsorbent removes 4-MeI forming a purified caramel color solution;
separating the purified caramel color solution from the adsorbant.

2. The process of claim 1 wherein the adsorbent is selected from the group consisting of activated carbon, zeolites, diatomaceous earth, and synthetic polymeric resins.

3. The process of claim 1 further comprising, prior to combining the caramel color solution with the adsorbent, raising the pH of the caramel color solution to foster the adsorbent pick up the 4-MeI.

4. The process of claim 3 wherein the pH is raised by mixing the caramel color solution with an alkali.

5. The process of claim 4 wherein the alkali is NaOH, KOH, or mixtures thereof.

6. The process of claim 4 wherein the amount of alkali is effective to raise the pH of the caramel color solution to at least 6.5

7. The process of claim 6 wherein the amount of alkali is effective to raise the pH of the caramel color solution to 6.5 to 9.

8. The process of claim 1 further comprising adding an acid to the purified caramel color solution to lower the pH to less than 5.

9. The process of claim 8 wherein the acid is HCl, H₃PO₄, citric acid, or mixtures thereof.

10. The process of claim 8 wherein the amount of acid is effective to lower the pH of the purified caramel color solution to 2 to 4.

11. The process of claim 8 further comprising, after adding the acid, subjecting the acidified caramel color solution to filtration to further remove salts.

12. The process of claim 11 wherein the filtration is nano-membrane filtration.

13. The process of claim 1 wherein the process is continuous.

14. A process of purifying a caramel color solution comprising:
introducing the caramel color solution into an adsorption column containing a fixed bed adsorbent, wherein the adsorbent removes 4-MeI, forming a purified caramel color solution;
removing the purified caramel color solution from the adsorption column; and
adding an acid to the purified caramel color solution to lower the pH to less than 5.

15. The process of claim 14 wherein the adsorbent is selected from the group consisting of activated carbon, zeolites, diatomaceous earth, and synthetic polymeric resins.

16. The process of claim 14 further comprising, prior to introducing the caramel color solution into an adsorption column, raising the pH of the caramel color solution to foster the adsorbent pick up the 4-MeI.

17. The process of claim 16 wherein the pH is raised by mixing the caramel color solution with an alkali.

18. The process of claim 17 wherein the alkali is NaOH, KOH, or mixtures thereof.

19. The process of claim 17 wherein the amount of alkali is effective to raise the pH of the caramel color solution to at least 6.5

20. The process of claim 14 wherein the acid is HCl, H₃PO₄, citric acid, or mixtures thereof.

21. The process of claim 14 wherein the amount of acid is effective to lower the pH of the purified caramel color solution to 2 to 4.

22. The process of claim 15 further comprising, after adding the acid, subjecting the acidified caramel color solution to filtration to further remove salts.

23. The process of claim 22 wherein the filtration is nano-membrane filtration.
